(19) United States
(12) Patent Application Publication
(10) Pub. No.: US 2007/0192364 A1
(43) Pub. Date: Aug. 16, 2007

(54) Apparatus and method for porting of business logic among computer platforms

(75) Inventor: Xiao Zhang, Austin, TX (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 11/321,601

(22) Filed: Dec. 29, 2005

(51) Int. Cl. G06F 17/00

(52) U.S. Cl. 707/104.1

(57) ABSTRACT

An apparatus and method port business logic between platforms in a non-platform specific manner to reduce the cost of porting and maintaining software across multiple platforms. In the preferred embodiments, a logic porting mechanism ports business logic of a first platform to business logic for a second platform using a multi-platform common mapping file. In other preferred embodiments, qualified business logic is identified and needed information is extracted and then the business logic from a first platform is mapped to business logic for a second platform using a common mapping file.

### BACKGROUND OF THE INVENTION

1. Technical Field

This invention generally relates to computer software systems, and more specifically relates to an apparatus and methods for porting business logic between computer platforms such as between a standalone platform and a web based platform.

2. Background Art

Computer software is an integral part of modern business operations. A business often uses many computer platforms due to diverse computer needs and changing business environments and software needs. It is increasingly costly to move or port business logic in a software system from one computer platform to another platform. The need for porting the business logic may be to upgrade existing software on one platform to match another platform, or to completely duplicate the business logic to the new platform.

Porting business logic from one platform to another often requires reprogramming from scratch in the new platform. This is obviously very costly. Existing approaches to translate from one platform to another are platform-specific and not very effective in translating to the new platform.

Without a way to more efficiently port business logic between computer platforms, businesses will continue to pay for costly computer upgrades and reprogramming to move their business logic and computer software to new platforms.

### DISCLOSURE OF INVENTION

According to the preferred embodiments, an apparatus and method port business logic between platforms in a non-platform specific manner to reduce the cost of porting and maintaining software across multiple platforms. In the preferred embodiments, a logic porting mechanism ports business logic of a first platform to business logic for a second platform using a multiple platform common mapping file. In other preferred embodiments, qualified business logic is identified and needed information is extracted and then the business logic from a first platform is mapped to business logic for a second platform using a common mapping file.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is block diagram that shows the logical relationship of the common mapping file with the different platforms;

FIG. 3 is a flow diagram of a method for porting business logic between platforms according to preferred embodiments;

FIGS. 4-9 illustrate an example of porting business logic according to preferred embodiments; and

FIG. 10 is a method flow diagram for porting business logic according to preferred embodiments.

### BEST MODE FOR CARRYING OUT THE INVENTION

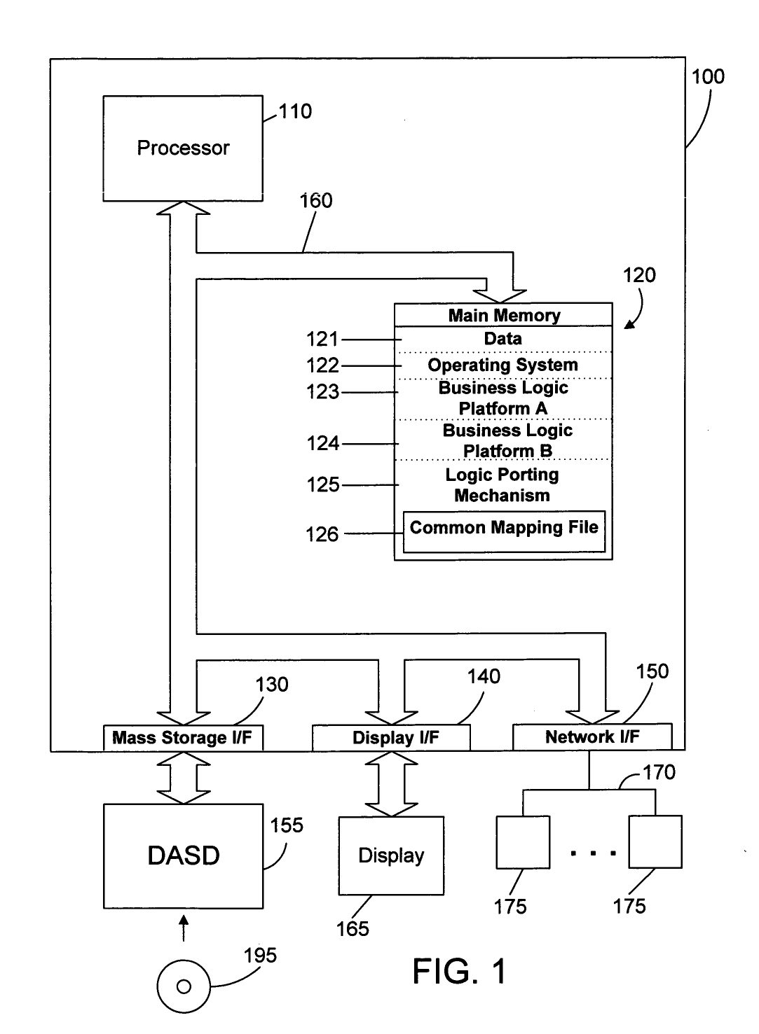

The preferred embodiments provide an apparatus and method to port business logic between platforms in a non-platform specific manner to reduce the cost of porting and maintaining software across multiple platforms. Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, business logic for platform A 123, business logic for platform B 124, a logic porting mechanism 125 and a common mapping file 126. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. The business logic for platform A 123, business logic for platform B 124, the logic porting mechanism 125 and the common mapping file 126, will be discussed below in more detail.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, business logic for platform A 123, business logic for platform B 124, logic porting mechanism 125 and the common mapping file 126 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links. Note that the preferred signal bearing media is tangible.

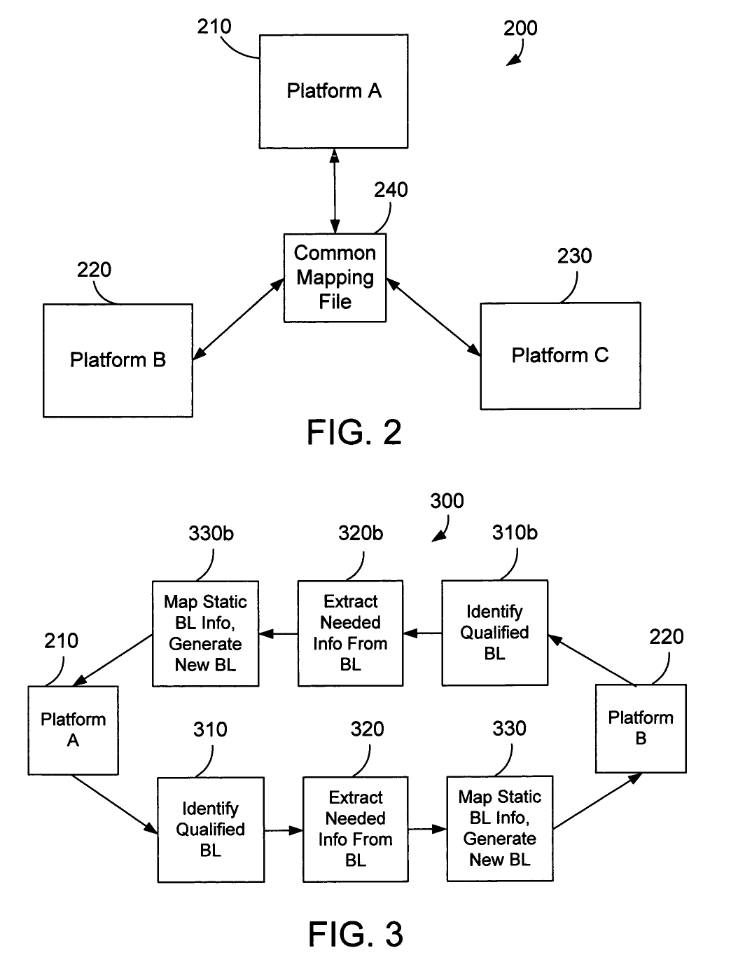

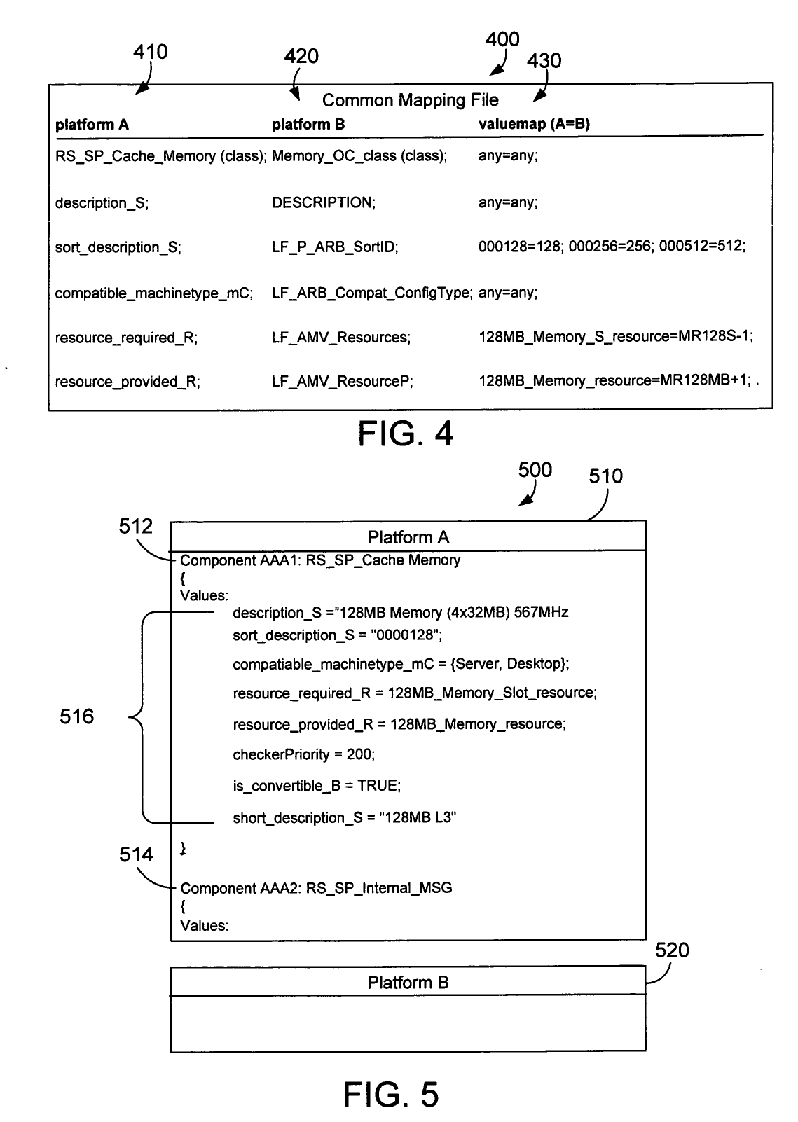

FIG. 2 illustrates a block diagram for porting business logic in accordance with the preferred embodiments. Business logic on platform A 210 can be ported to logic on platform B 220 and platform C 230. Business logic includes software objects in a business software application or program. To facilitate porting the business logic, a common mapping file 240 is created. It is initially contemplated that this will be at least a partially manual process by a software developer to match all the data attributes/values from one platform to the other using the developer's existing platform knowledge to create the common mapping. This process is described further below with reference to FIG. 4.

FIG. 3 illustrates a block diagram that shows the basic steps for porting logic in accordance with the preferred embodiments. Logic on platform A 210 can be ported to logic on platform B 220, and similarly, logic on platform B 220 can be ported to platform A 210. Platform A 210 represents a “standalone” platform and platform B represents a web-based platform. The steps shown in FIG. 3 will be described further below. The first task is to identify qualified business logic 310. In the next step, needed information is extracted from the qualified business logic 320. The extracted information is then used in conjunction with the common mapping file to generate new business logic 330 to create a similar logic structure in platform B 220. Similarly, logic on platform B 220 can be ported to platform A 210 with the same steps, i.e. identify qualified business logic 310b, extract the need information from the qualified business logic 320b, and map the business logic to generate new business logic 330b to create a similar logic structure in platform A 210.

FIGS. 4 through 9 will now be described to illustrate an example of the preferred embodiments. FIG. 4 shows a common mapping file 400 used to port the business logic for this example. The common mapping file is created by listing all data attributes of a program and their possible values to create a multi-platform mapping file. The developer chooses those data attributes/values that are common between different platforms and discards those data attributes/values that are not common between different platforms or are not meaningful to port for whatever reason. The developer then matches all the data attributes/values from one platform to the data attributes and values of another platform using the developer's existing platform knowledge to create the common mapping file 400. Creating the mapping file herein is described as a manual process but portions of the process could be automated and it may be developed into a fully automated process.

Again referring to FIG. 4, a common mapping file 400 has columns for platform A 410, platform B 420 and a valuemap 430. The valuemap 430 is in the format of “A=B,” meaning, value for platform A equal to value for platform B. In a common mapping file for multiple platforms (not shown) the valuemap would be of the form “A=B=C.” The first line 410 in the common mapping file 400 lists a class RS_SP_Cache_Memory in platform A that is mapped to the class Memory_OC in platform B. The valuemap 430 for this class mapping is shown as “any=any,” which means any object in class RS_SP_Cache_Memory will be mapped to any object in class Memory_OC. Similarly, the valuemap for the attribute description_S is “any=any” which means any value for the attribute on platform A will be mapped to the same attribute value in platform B. In contrast, the attribute Sort_description_S has a valuemap of 000128=128; 000256=256; 000512=512. In this valuemap a string of the first attribute is mapped to an integer of the corresponding attribute in the target platform (platform B). Similarly, the attribute resouce_required_R has a valuemap 128 MB_Memory_S_resource=MR128S−1. The values in this valuemap represent mnemonics for memory slot resources on platform A and Platform B respectfully.

The first step to port the business logic from platform A to platform B is to identify the logic on platform A. FIG. 5 illustrates some business logic that has been identified in platform A 510 to be ported to platform B. The data is identified by extracting the data structure from the business logic of platform A which shows the parent-child relationship of the data and expressing the extracted data in a format as shown. The business logic in FIG. 5 includes a first component AAA1 512 and a second component AAA2 514. The first component AAA1 512 (RS_SP_Cache Memory) represents a component class with values 516 as shown. The second component AAA2 514 (RS_SP_Internal_MSG) represents another component class but no values are shown for this component.

The next step to port the business logic from platform A to platform B is to determine what logic is qualified logic that can be ported among different platforms. Software objects that meets certain criteria, such belonging to certain classes, having certain attribute values, etc. are qualified logic. This step depends on a developer's knowledge of the platforms to determine the criteria for what logic can be qualified. This step may be automated to be performed by the logic porting mechanism to assist the developer to select the qualified logic.

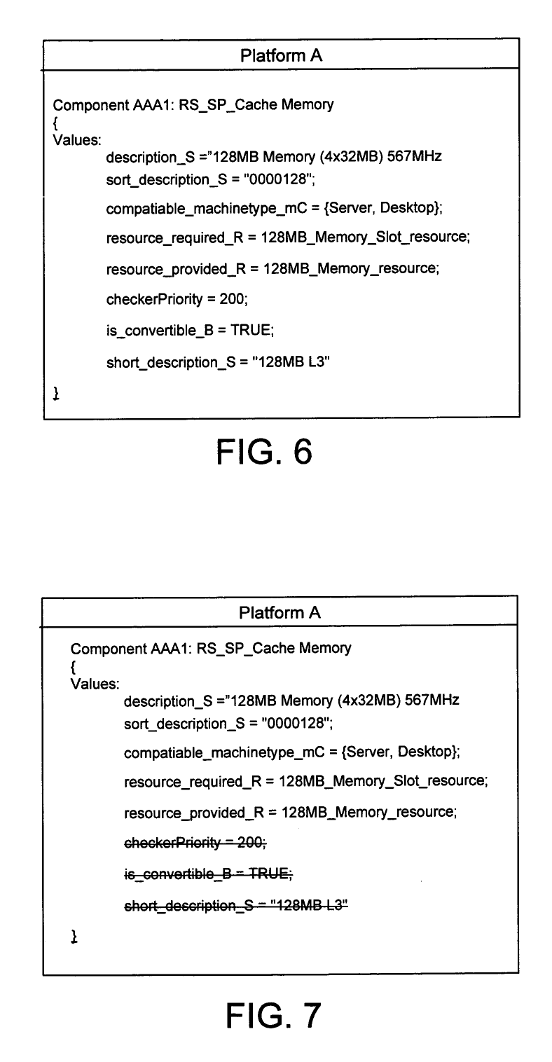

In the illustrated example of FIGS. 4 through 9, the component AAA1 is determined to meet the qualified criteria, while component AAA2 is determined to not meet the qualified criteria. Component AAA2 is of a class that is not qualified, in this case because the class is determined to be platform-specific. After the qualifying step, the business logic 500 is reformulated as shown in FIG. 6. The business logic in FIG. 6 represents only qualified logic having the component AAA1 of the qualified class RS_SP_Cache Memory.

The next step to port the business logic from platform A to platform B is to extract the information that can be ported from the qualified logic shown in FIG. 6. Not all information is needed and may be platform-specific and cannot be ported. In the illustrated example, the attribute/value pairs ‘checkerPriority=200′, is_convertible_B=true’, and ‘short_description_S=“128 MB L3” can not be ported. The items that can not be ported are removed from the data structure and must be handled manually. The data to be ported is shown in FIG. 7 with the removed data shown with strikethrough to illustrate the step. The logic porting mechanism is utilized to assist the developer to extract the logic information in this step.

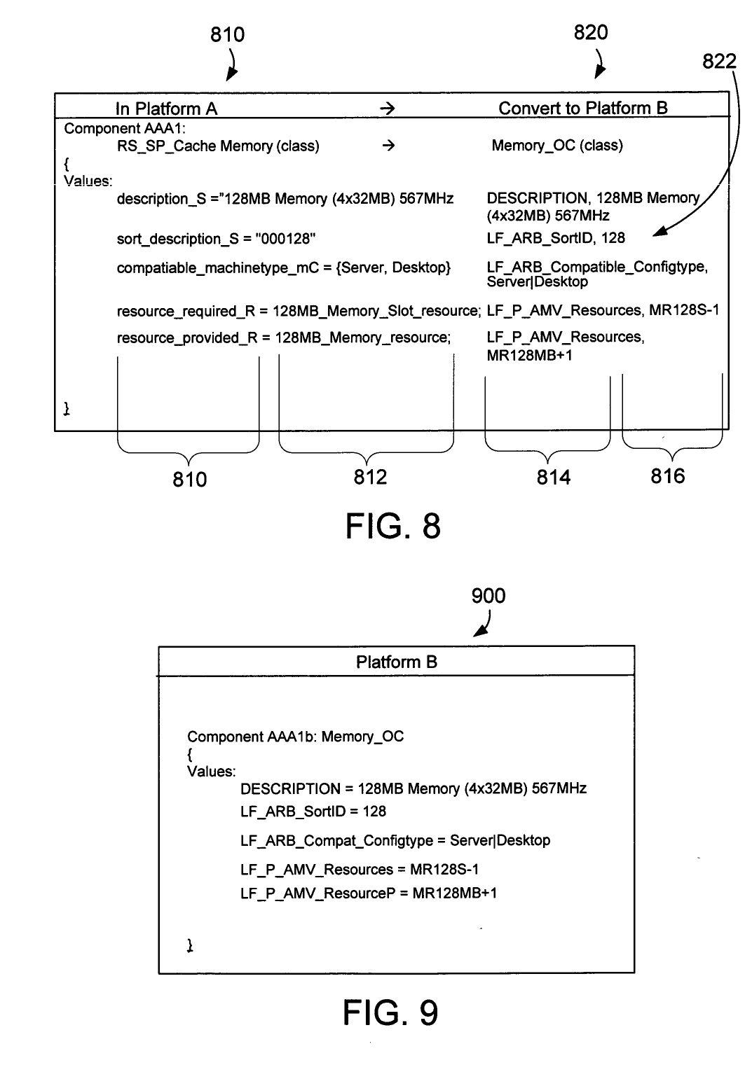

The next step to port the business logic from platform A to platform B is to map the logic information extracted from the platform A to logic of platform B using the common mapping file. FIG. 8 shows the mapping step for the illustrated example. Each attribute 810 value 812 pair from platform A is mapped to an attribute 814 value 816 pair in the target platform (platform B). The common mapping file includes a valuemap 430 that gives a range of values fore each attribute of the first source platform (platform A). The logic porting mechanism determines the value for an attribute in the second platform (platform B) that is within the range of attribute values given in the common mapping file for the corresponding attribute for the first platform. For example, the attribute “short_description_S in platform A is found to correspond to attribute LF_ARB_SortID in platform B from the common mapping file 400. The value in platform A (000128) is also found to correspond to the value “128” in platform B. So the mapping is then performed by generating a attribute value pair in platform B of “LF_ARB_SortID, 128” 822 as shown in FIG. 8.

FIG. 9 shows the final step to port the business logic from platform A to platform B. The corresponding logic in platform B 900 is created using the logic determined in the previous mapping step (FIG. 8) as shown. A component AAA1b is created with the class ‘Memory_OC’ as determined from the previous step. The component AAA1b also includes the attribute—value pairs determined in the previous step.

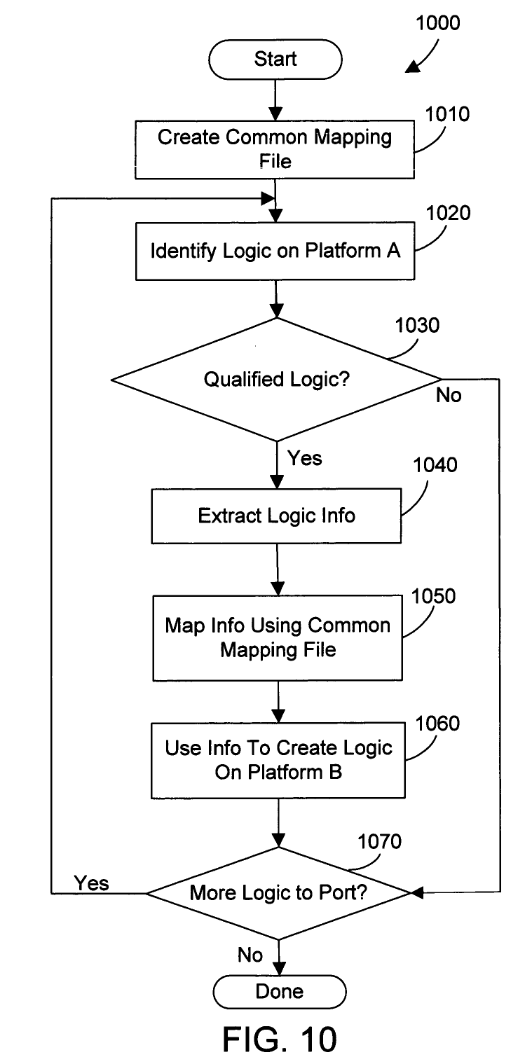

Referring now to FIG. 10, a method 1000 in accordance with preferred embodiments is illustrated. Method 1000 begins by creating a common mapping file (step 1010). The logic in platform A is identified (step 1020) and then checked to see if the logic is qualified (step 1030). If the logic is not qualified (step 1030=no) then the method jumps to step 1070 to continue. If the logic is qualified (step 1030=yes) then the method extracts the qualified logic information (step 1040). The extracted logic from platform A is then used with the common mapping file to map the extracted logic information (step 1050) and create corresponding logic on platform B (step 1060). If there is more logic to port (step 1070=yes) then the method returns to step 1020. If there is no more logic to port (step 1070=no) then the method is done.

The embodiments described herein provide an improved method and apparatus for porting business logic from one platform to another platform to reduce the costs for reprogramming business logic onto new platforms. The embodiments further provide for more efficiently porting business logic between computer platforms for upgrades and reprogramming by creating a platform independent, mapping file (common mapping file) and using a logic porting mechanism to process the business logic through the common mapping file.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor; and
a logic porting mechanism in the memory that ports business logic between the format of a first platform to business logic for a second platform using a common mapping file.

2. The apparatus of claim 1 wherein the common mapping file has corresponding attribute value pairs for the first and second platforms.

3. The apparatus of claim 1 wherein the business logic ported by the logic porting mechanism is qualified business logic.

4. The apparatus of claim 3 wherein qualified business logic is software objects that meet established criteria for porting to multiple platforms.

5. The apparatus of claim 4 wherein the established criteria includes criteria such as the following: belonging to certain classes, and having certain attribute values.

6. The apparatus of claim 1 wherein the logic porting mechanism determines the value for an attribute in the second platform that is within the range of attribute values given in the common mapping file for the corresponding attribute for the first platform.

7. A computer-implemented method for porting business logic from a first platform to a second platform, the method comprising the steps of:
identifying qualified business logic;
extracting needed information from the qualified business logic; and
mapping the business logic from the first platform to business logic for a second platform using a common mapping file.

8. The method of claim 7 further comprising the step of creating corresponding business logic in the second platform.

9. The method of claim 7 wherein the step of identifying qualified business logic further comprises determining software objects that meet established criteria for porting to multiple platforms.

10. The method of claim 9 wherein the established criteria includes criteria such as the following: belonging to certain classes, and having certain attribute values.

11. The method of claim 7 further comprising the step of determining the value for an attribute in the second platform that is within the range of attribute values given in the common mapping file for the corresponding attribute for the first platform.

12. A computer-readable program product comprising:
(A) a logic porting mechanism that ports business logic between the format of a first platform to business logic a second platform using a common mapping file; and
(B) computer-recordable signal bearing media bearing the logic porting mechanism.

13. The program product of claim 12 wherein the common mapping file has corresponding attribute value pairs for the first and second platforms.

14. The program product of claim 12 wherein the business logic ported by the logic porting mechanism is qualified business logic.

15. The program product of claim 14 wherein the wherein qualified business logic is software objects that meet established criteria for porting to multiple platforms.

16. The program product of claim 15 wherein the established criteria includes criteria such as the following: belonging to certain classes, and having certain attribute values.

17. The program product of claim 12 wherein the logic porting mechanism determines the value for an attribute in the second platform that is within the range of attribute values given in the common mapping file for the corresponding attribute for the first platform.
